(19) United States
(12) Patent Application Publication
(10) Pub. No.: US 2016/0028789 A1
(43) Pub. Date: Jan. 28, 2016

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventors: Kohshiro INOMATA, Kanagawa (JP); Tetsuo FUKASAWA, Kanagawa (JP)

(21) Appl. No.: 14/635,382

(22) Filed: Mar. 2, 2015

(30) Foreign Application Priority Data
Jul. 25, 2014 (JP) 2014-152006

(51) Int. Cl. H04L 29/06; H04M 3/56

(52) U.S. Cl. CPC H04L 65/604; H04L 65/1083; H04L 65/4038; H04M 3/567

(57) ABSTRACT

A non-transitory computer readable medium stores a program causing a computer to execute a process for allowing at least part of display content of a second terminal apparatus included in multiple terminal apparatuses to be displayed on at least a portion of a display screen of a first terminal apparatus included in the multiple terminal apparatuses in such a manner that the first terminal apparatus is in a synchronous state. The process includes acquiring first operation content indicating content of an operation performed by a first user on the first terminal apparatus; and modifying, in a case where the first operation content indicates content of an operation of modifying display content displayed on the first terminal apparatus in synchronization with the second terminal apparatus and indicates content of a predetermined operation, the display content displayed on the first terminal apparatus to display content corresponding to the first operation content.

### CROSS-REFERENCE TO RELATED APPLICATIONS

This application is based on and claims priority under 35 USC 119 from Japanese Patent Application No. 2014-152006 filed Jul. 25, 2014.

### BACKGROUND

(i) Technical Field

The present invention relates to an information processing apparatus, an information processing system, and a non-transitory computer readable medium.

(ii) Related Art

A teleconferencing system has recently been used in conferences. The teleconferencing system includes personal computers (PCs), tablet terminals, and similar devices connected to one another via a network to share electronic data of the conference materials and the like. The teleconferencing system allows synchronization of a terminal apparatus used by a person who makes a presentation (hereinafter referred to as a “presenter terminal”) and terminal apparatuses used by other persons who take part in the conference participants (hereinafter referred to as “participant terminals”) so that display content (such as a displayed page of the materials) on a display screen of the presenter terminal is synchronously displayed on display screens of the participant terminals.

In the teleconferencing system described above, there has been proposed a technique that allows a participant to switch the state of their participant terminal to an asynchronous state to display content different from the display content of the presenter terminal.

### SUMMARY

According to an aspect of the invention, there is provided a non-transitory computer readable medium storing a program causing a computer to execute a process for allowing at least part of display content of a second terminal apparatus included in multiple terminal apparatuses to be displayed on at least a portion of a display screen of a first terminal apparatus included in the multiple terminal apparatuses in such a manner that the first terminal apparatus is in a synchronous state. The process includes acquiring first operation content indicating content of an operation performed by a first user on the first terminal apparatus; and modifying, in a case where the first operation content indicates content of an operation of modifying display content displayed on the first terminal apparatus in synchronization with the second terminal apparatus and indicates content of a predetermined operation, the display content displayed on the first terminal apparatus to display content corresponding to the first operation content.

### BRIEF DESCRIPTION OF THE DRAWINGS

An exemplary embodiment of the present invention will be described in detail based on the following figures, wherein:

FIG. 1 is an overall configuration diagram of a teleconferencing system according to an exemplary embodiment;

FIG. 2 is a block diagram illustrating a hardware configuration of an operation terminal;

FIG. 3 is a functional block diagram illustrating a specific configuration of a participant terminal;

FIG. 4 illustrates an example of a network configuration of the teleconferencing system;

FIG. 5 illustrates an example of display content displayed on a display screen of a presenter terminal;

FIG. 6 illustrates an example of an operation type table;

FIG. 7 is an operation flow diagram of the teleconferencing system;

FIG. 8 is an operation flow diagram of the teleconferencing system;

FIG. 9 is a functional block diagram illustrating a specific configuration of a participant terminal in a teleconferencing system according to a fifth modification;

FIG. 10 illustrates an example of an operation type table;

FIG. 11 illustrates another example of the operation type table;

FIG. 12 is an operation flow diagram of the teleconferencing system according to the fifth modification;

FIG. 13 is a functional block diagram illustrating a specific configuration of a teleconferencing system according to an eighth modification;

FIG. 14 is a functional block diagram illustrating a specific configuration of a teleconferencing system according to a ninth modification;

FIG. 15 illustrates another example of the network configuration of the teleconferencing system; and

FIG. 16 illustrates another example of the network configuration of the teleconferencing system.

### DETAILED DESCRIPTION

An exemplary embodiment of the present invention will be described hereinafter with reference to the drawings. In this exemplary embodiment, a teleconferencing system that allows multiple terminal apparatuses connected via a network to share electronic data will be described as an example of an information processing system.

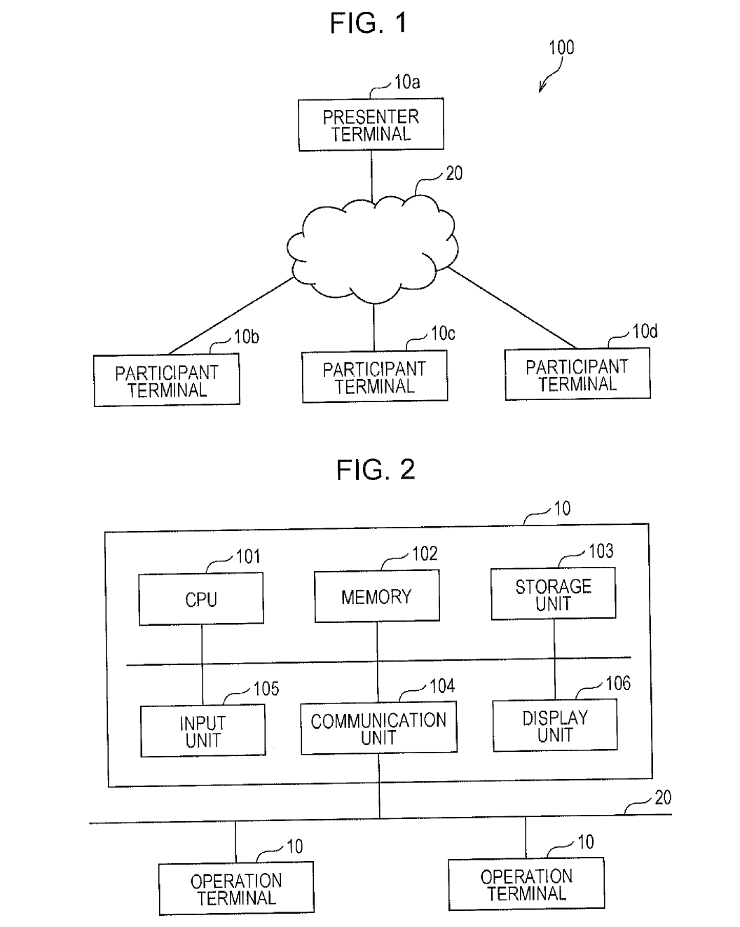

FIG. 1 is an overall configuration diagram of the teleconferencing system according to this exemplary embodiment. A teleconferencing system 100 (an information processing system) includes multiple operation terminals 10, each of which is used by one of multiple users who participate in a conference. In this exemplary embodiment, for convenience of illustration, a user who may play the leading role of the conference, such as a sponsor of the conference, a moderator of the conference, or a person who makes a presentation in the conference, is referred to as a “presenter” (a second user), and an operation terminal used by the presenter is referred to as a “presenter terminal” (a second terminal apparatus). Further, each of other users who participate in the conference is referred to as a “participant” (a first user), and an operation terminal used by each of the participants is referred to as a “participant terminal” (a first terminal apparatus). In FIG. 1, one presenter terminal 10a and three participant terminals 10b, 10c, and 10d are illustrated. In the following description, the presenter terminal 10a and the participant terminals 10b, 10c, and 10d are collectively referred to as the “operation terminal 10” to discuss a common configuration.

As illustrated in FIG. 1, the presenter terminal 10a is connected to the participant terminals 10b, 10c, and 10d via a communication network 20 such as a local area network (LAN) or the Internet.

FIG. 2 is a block diagram illustrating a hardware configuration of the operation terminal 10. The operation terminal 10 is composed of a computer including a central processing unit (CPU) 101, a memory 102, a storage unit 103, a communication unit 104, an input unit 105, and a display unit 106. The hardware elements described above are connected to one another via a bus so as to allow mutual transmission and reception of data. The CPU 101 controls each unit of the operation terminal 10, and executes various kinds of information processing. The memory 102 holds various programs and data. The memory 102 also has a working area for the CPU 101. The storage unit 103 stores data of various files, documents, and the like. The communication unit 104 performs data communication with another operation terminal 10 via the communication network 20. The input unit 105 is an input device such as a keyboard, a mouse, a pen tool, or a touch panel. The display unit 106 is a display screen on which various files, documents, and the like are displayed by using application software such as a web browser. The storage unit 103, the input unit 105, and the display unit 106 may be provided outside the operation terminal 10, and may be connected to the operation terminal 10 via the communication network 20. The operation terminal 10 has incorporated therein software such as a browser or an electronic mail client. The operation terminal 10 may be, for example, a mobile information terminal such as a personal computer, a personal digital assistant (PDA), or a smartphone.

In the following, a specific configuration of the teleconferencing system 100 will be described, focusing on the presenter terminal 10a and the participant terminal 10b.

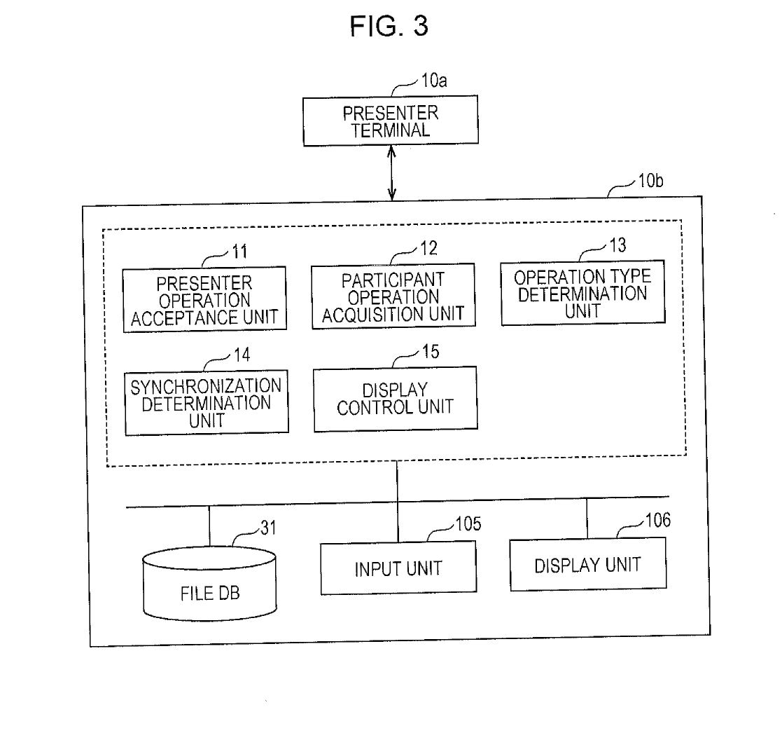

FIG. 3 is a functional block diagram illustrating a specific configuration of the participant terminal 10b. The participant terminal 10b includes a presenter operation acceptance unit 11, a participant operation acquisition unit 12, an operation type determination unit 13, a synchronization determination unit 14, and a display control unit 15. The elements described above are implemented by the CPU 101 executing a program stored in the memory 102 (see FIG. 2). The storage unit 103 includes a file database (DB) 31 to which data for various files, documents, and so forth are saved.

The program may be installed to the participant terminal 10b from a computer-readable information storage medium such as a compact disc read-only memory (CD-ROM), a digital versatile disc ROM (DVD-ROM), or a memory card, or may be downloaded via the communication network 20, such as the Internet, or downloaded from a server in which the program is stored in advance.

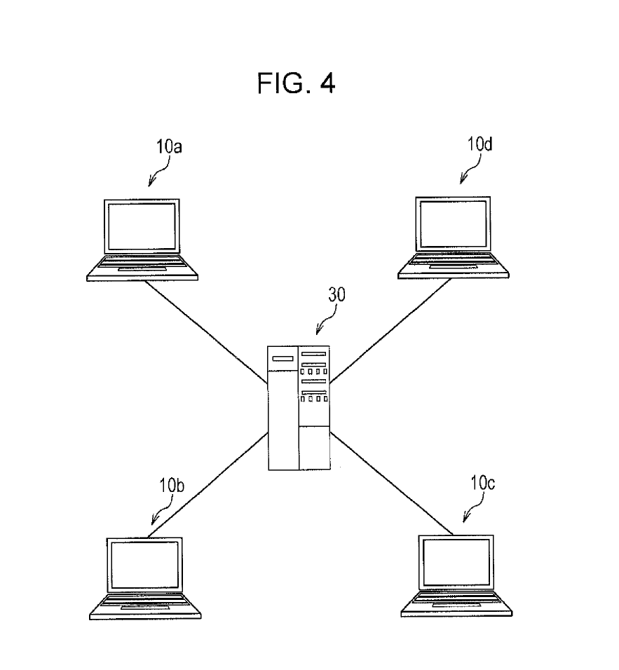

For example, as illustrated in FIG. 4, in a network configuration in which each operation terminal 10 is connected to a network via a server 30, the program may be downloaded from the server 30 to the memory 102 of each of the participant terminals 10b, 10c, and 10d, and material data for the conference materials may be downloaded to the file DB 31 at the time when the participant terminals 10b, 10c, and 10d are connected to the server 30. The program and the material data may be created by, for example, JavaScript (registered trademark). Further, a presenter connects an operation terminal 10 to the server 30 and performs predetermined settings to recognize the operation terminal 10 as the presenter terminal 10a, and a participant connects an operation terminal 10 to the server 30 and performs predetermined settings to recognize the operation terminal 10 as the participant terminal 10b or the like. The server 30 transmits the program and the material data to the individual operation terminals 10 recognized as participant terminals. The server 30 may also transmit the program and the material data to the operation terminal 10 recognized as a presenter terminal. After the transmission of the program and the material data, the server 30 mainly functions as a relay for information communication between the presenter terminal 10a and the participant terminals 10b, 10c, and 10d. The operation terminals 10 to or on which the program described above has been downloaded or recorded each function as an information processing apparatus. In addition, a computer to which the program described above has been downloaded may be an operation terminal 10 or may be the server 30.

The functions corresponding to the program described above will now be described.

The presenter operation acceptance unit 11 accepts, from the presenter terminal 10a, information indicating the content of an operation performed by the presenter on the presenter terminal 10a (hereinafter referred to as “presenter operation information”) (second operation content). The presenter operation information is information indicating the content of an operation such as displaying new materials, writing on the materials with a pen tool (a handwriting tool), picking up (or selecting) a posted comment, switching the page of the materials, displaying and moving the mouse pointer, and receiving audio input.

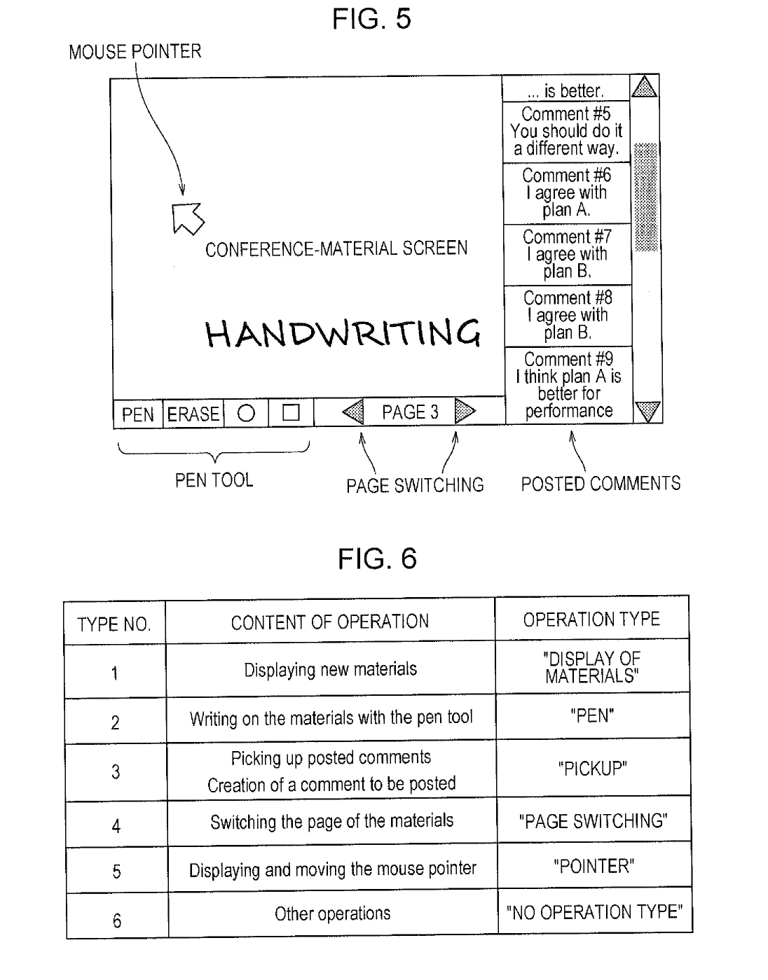

A description will now be given of a specific example of a process performed by the presenter terminal 10a. FIG. 5 illustrates an example of display content on a display screen of the presenter terminal 10a.

For example, the presenter operates the mouse or the like (the input unit 105) of the presenter terminal 10a to read materials saved in the file DB 31 (or to display the materials on a conference-material screen). In this case, the presenter terminal 10a notifies (or transmits) the participant terminal 10b of the presenter operation information indicating the content of the operation described above, which includes information indicating the Uniform Resource Locator (URL) of the destination to which the materials are saved or the material ID, via the communication unit 104.

For example, the presenter operates the mouse of the presenter terminal 10a to display the mouse pointer on the conference-material screen (see FIG. 5) displayed on the display unit 106. In this case, the presenter terminal 10a notifies the participant terminal 10b of the presenter operation information indicating the content of the operation described above, which includes information indicating the location (or coordinates) of the mouse pointer, the ID and page number of the materials on which the mouse pointer is displayed, and so forth, via the communication unit 104. The presenter terminal 10a may sequentially transmit the presenter operation information at certain time intervals (for example, every 50 msec).

For example, the presenter operates the pen tool in the presenter terminal 10a to write characters and the like on the conference-material screen (see FIG. 5) displayed on the display unit 106. In this case, the presenter terminal 10a notifies the participant terminal 10b of the presenter operation information indicating the content of the operation described above, which includes information indicating the location (or coordinates) at which the characters and the like are written, the ID and page number of the materials on which the characters and the like are written, and so forth, via the communication unit 104.

For example, the presenter operates the mouse of the presenter terminal 10a to switch the page for the conference-material screen (see FIG. 5) displayed on the display unit 106. In this case, the presenter terminal 10a notifies the participant terminal 10b of the presenter operation information indicating the content of the operation described above, which includes information indicating the ID of the displayed materials and the designated page number, via the communication unit 104.

In the way described above, in response to an operation performed by the presenter, the presenter terminal 10a notifies the participant terminals 10b, 10c, and 10d of information indicating the content of the operation.

The participant operation acquisition unit 12 acquires information indicating the content of an operation performed by the participant on the participant terminal 10b (hereinafter referred to as “participant operation information”) (first operation content). Similarly to the presenter operation information, the participant operation information is information indicating the content of an operation such as displaying the materials, writing on the materials with a pen tool, creating a posted comment, switching the page of the materials, displaying and moving the mouse pointer, and receiving audio input.

The operation type determination unit 13 determines an operation type (a presenter operation type) in accordance with the presenter operation information accepted from the presenter terminal 10a by the presenter operation acceptance unit 11. The operation type determination unit 13 further determines an operation type (a participant operation type) in accordance with the participant operation information acquired by the participant operation acquisition unit 12 in the associated terminal (i.e., the participant terminal 10b). Operations performed by the presenter and the participant are classified by type. The operation types are set in advance, and are saved in the storage unit 103 as items in an operation type table, by way of example. The operations registered in the operation type table are operations that are meaningful for the presenter and the participant, examples of which include modifying display content (or synchronized content) displayed on the participant terminal 10b in synchronization with the presenter terminal 10a. The modifying operation is, specifically, an operation of modifying the display content of the participant terminal 10b by, while the first page of materials A displayed on the presenter terminal 10a is being displayed on the participant terminal 10b in a synchronous fashion, switching to the second page. Another specific example of the modifying operation is an operation of modifying the display content of the participant terminal 10b by, while the first page of the materials A displayed on the presenter terminal 10a is being displayed on the participant terminal 10b in a synchronous fashion, displaying the mouse pointer on the first page.

The synchronized content may be displayed on the entire display screen of the participant terminal 10b or on a portion of the display screen. In addition, the entire display screen of the presenter terminal 10a or a portion of the display screen may be synchronized. Thus, for example, even in a case where the mouse pointer operated by the presenter on the presenter terminal 10a is synchronously moving on the participant terminal 10b (synchronous state), the mouse pointer for the participant terminal 10b may be displayed separately (for example, outside the synchronized display screen). Alternatively, both the mouse pointer in the synchronous state, which is operated by the presenter, and the mouse pointer for the participant terminal 10b, which is operated by the participant, may appear on the synchronized display screen. The operation of displaying the mouse pointer on the presenter terminal 10a is involved in the operation of modifying the display content of the participant terminal 10b.

FIG. 6 illustrates an example of the operation type table. In the operation type table illustrated in FIG. 6, five operation types, namely, “Display of materials”, “Pen”, “Pickup”, “Page switching”, and “Pointer”, are set so as to correspond to the content of the respective operations. For example, the operation type determination unit 13 refers to the operation type table, and designates an operation type corresponding to an operation performed by the presenter. The operation type determination unit 13 further refers to the operation type table, and designates an operation type corresponding to an operation performed by the participant. If there is no operation type corresponding to the operation, the operation type determination unit 13 determines “No operation type” exists. The operations registered in the operation type table are not limited to those illustrated in FIG. 6. For example, the content of the operations and the operation types for the presenter and the content of the operations and the operation types for the participant, which are different from each other, may be registered in the operation type table. In this case, an operation type table for the presenter and an operation type table for the participant may be separately provided.

The synchronization determination unit 14 determines whether to make the participant terminal 10b synchronous or asynchronous with the presenter terminal 10a, in accordance with the determination result of the operation type determination unit 13. Specifically, if the operation performed by the presenter corresponds to a predetermined operation type (see FIG. 6), the synchronization determination unit 14 determines that the participant terminal 10b is “synchronous”. If the operation performed by the participant corresponds to a predetermined operation type (see FIG. 6), the synchronization determination unit 14 determines that the participant terminal 10b is “asynchronous”. If the operation type of the operation performed by the presenter or the operation type of the operation performed by the participant corresponds to “No operation type”, the synchronization determination unit 14 determines that the participant terminal 10b is “asynchronous”.

The display control unit 15 controls the display content on the display screen of the participant terminal 10b in accordance with the determination result of the synchronization determination unit 14. Specifically, if the synchronization determination unit 14 determines that the participant terminal 10b is “synchronous”, the display control unit 15 causes display content corresponding to the content of the operation performed by the presenter to be reflected and displayed on the participant terminal 10b. For example, when the presenter displays new materials A on the presenter terminal 10a, the synchronization determination unit 14 determines that the participant terminal 10b is “synchronous”, and the display control unit 15 causes the materials A to be displayed on the display unit 106 of the participant terminal 10b. For example, when the presenter switches the displayed page of the materials A from the first page to the second page on the presenter terminal 10a, the synchronization determination unit 14 determines that the participant terminal 10b is “synchronous”, and the display control unit 15 switches the displayed page of the materials A being displayed on the display unit 106 of the participant terminal 10b from the first page to the second page. Similarly, when the presenter writes characters with a pen tool, picks up a posted comment, or moves the mouse pointer, the display control unit 15 causes the content of the corresponding operation to be reflected to the participant terminal 10b.

On the other hand, if the synchronization determination unit 14 determines that the participant terminal 10b is “asynchronous”, the display control unit 15 makes the participant terminal 10b asynchronous with the presenter terminal 10a (asynchronous mode), and causes the content of the operation performed by the participant to be reflected to the participant terminal 10b. For example, when the participant selects different materials B while the materials A is being displayed on the participant terminal 10b in synchronization with the presenter terminal 10a, the synchronization determination unit 14 determines that the participant terminal 10b is “asynchronous”, and the display control unit 15 makes the participant terminal 10b asynchronous with the presenter terminal 10a, modifies the display content of the participant terminal 10b, and causes the materials B to be displayed on the display unit 106. For example, while the third page of the materials A is being displayed on the participant terminal 10b in synchronization with the presenter terminal 10a, if the participant switches to the next page (i.e., the fourth page), the synchronization determination unit 14 determines that the participant terminal 10b is “asynchronous”, and the display control unit 15 makes the participant terminal 10b asynchronous with the presenter terminal 10a, and switches (or modifies) the displayed page of the materials A being displayed on the display unit 106 of the participant terminal 10b from the third page to the fourth page. Similarly, when the participant writes characters with a pen tool, creates a comment to be posted, or moves the mouse pointer, the display control unit 15 makes the participant terminal 10b asynchronous with the presenter terminal 10a, and causes the content of the corresponding operation to be reflected to the participant terminal 10b.

Accordingly, the display control unit 15 functions as a synchronization cancellation unit that cancels the synchronous state (or switches to the asynchronous state) in response to a preset operation performed by the participant on the participant terminal 10b, and functions as a re-synchronization unit that reverts to the synchronous state (or cancels the asynchronous state) in response to a preset operation performed by the presenter on the presenter terminal 10a in a state where the synchronous state has been canceled (i.e., the asynchronous state).

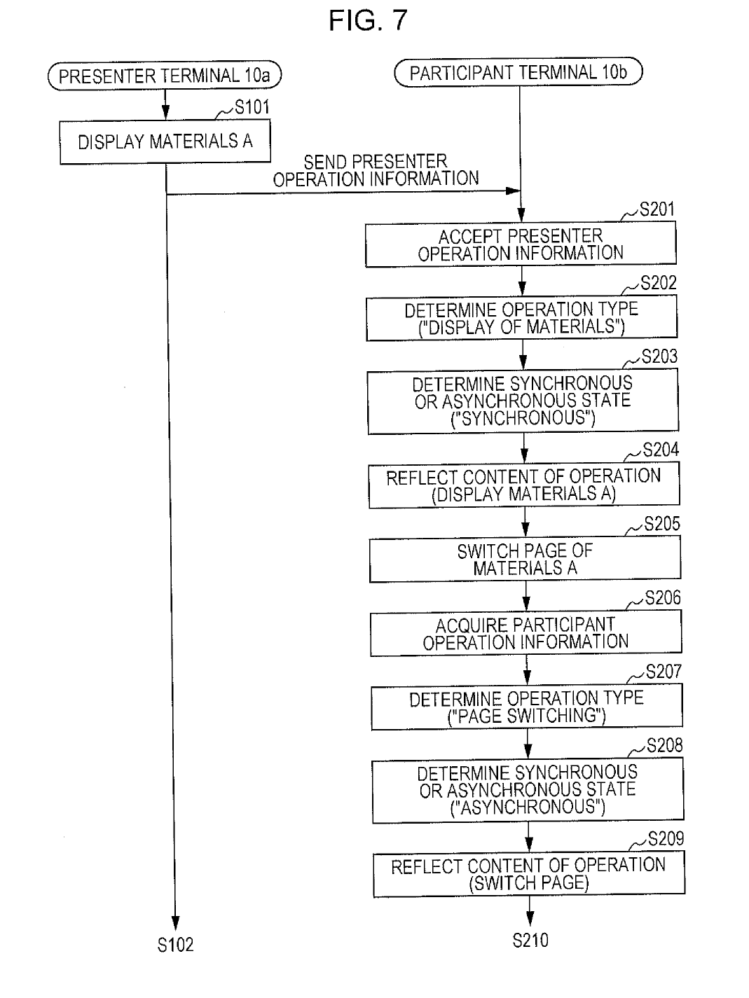

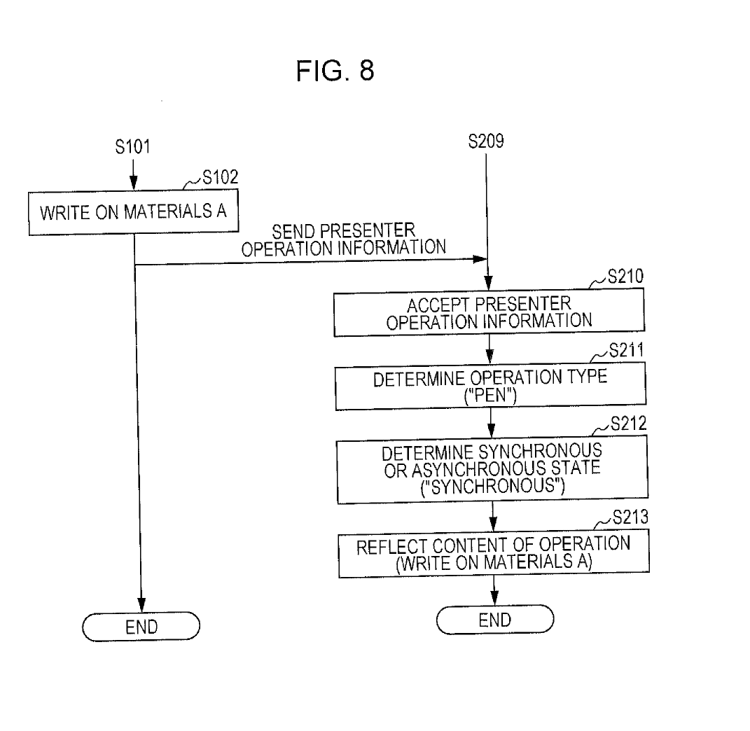

A process flow in the teleconferencing system 100 will now be described. FIG. 7 and FIG. 8 are operation flow diagrams of the teleconferencing system 100. A description will be given, assuming that, by way of example, a presenter P makes a presentation on the materials A in a teleconference by using the presenter terminal 10a, a participant S participates in the teleconference by using the participant terminal 10b, and the teleconference proceeds during which the presenter P and the participant S perform desired operations. While the teleconferencing system 100 includes a single presenter terminal and multiple participant terminals which are connected to each other via the communication network 20, the following description focuses on the presenter terminal 10a and the participant terminal 10b.

Initially, the presenter P selects a file of the materials A saved in the storage unit 103 (FIG. 2) of the presenter terminal 10a. Thus, the content of the materials A is displayed on the display unit 106 of the presenter terminal 10a (S101). For example, the top page (i.e., the first page) of the materials A is displayed. The presenter terminal 10a notifies the participant terminal 10b of presenter operation information indicating the content of the operation performed by the presenter P (here, displaying new materials A), which includes information on the materials A (for example, the ID and page number of the materials A).

Then, the presenter operation acceptance unit 11 of the participant terminal 10b accepts the presenter operation information from the presenter terminal 10a (S201). Here, the presenter operation acceptance unit 11 accepts the content of the operation (“displaying new materials A”) including the ID of the materials A.

Then, the operation type determination unit 13 of the participant terminal 10b determines an operation type in accordance with the presenter operation information (S202). Here, the operation type determination unit 13 refers to the operation type table illustrated in FIG. 6, and designates an operation type (“Display of materials”) corresponding to the content of the operation (“displaying new materials A”).

Then, the synchronization determination unit 14 of the participant terminal 10b determines whether the participant terminal 10b is synchronous or asynchronous, in accordance with the determination result of the operation type determination unit 13 (S203). Here, “Display of materials” is designated as the operation type. Thus, the synchronization determination unit 14 determines that the participant terminal 10b is “synchronous”.

Then, the display control unit 15 of the participant terminal 10b controls the display content on the display screen of the participant terminal 10b in accordance with the determination result of the synchronization determination unit 14 (S204). Here, the synchronization determination unit 14 determines that the participant terminal 10b is “synchronous”. Thus, the display control unit 15 causes the first page of the materials A to be displayed on the display unit 106 of the participant terminal 10b.

In the processing of S201 to S204 described above, the presenter terminal 10a and the participant terminal 10b are in a synchronous state (synchronous mode), and the same content is displayed.

Then, the participant S performs a desired operation on the participant terminal 10b. Here, it is assumed that the participant S switches the displayed page (i.e., the first page) of the materials A being displayed on the display screen to the second page (S205).

Then, the participant operation acquisition unit 12 of the participant terminal 10b acquires participant operation information indicating the content of the operation performed by the participant S. Here, the participant terminal 10b acquires participant operation information indicating the content of the operation performed by the participant S (here, switching the page of the materials A), which includes information on the materials A (for example, the ID of the materials A) (S206).

Then, the operation type determination unit 13 of the participant terminal 10b determines an operation type in accordance with the participant operation information (S207). Here, the operation type determination unit 13 refers to the operation type table illustrated in FIG. 6, and designates an operation type (“Page switching”) corresponding to the content of the operation (“switching the page of the materials A”).

Then, the synchronization determination unit 14 of the participant terminal 10b determines whether the participant terminal 10b is synchronous or asynchronous, in accordance with the determination result of the operation type determination unit 13 (S208). Here, “Page switching” is designated as the operation type. Thus, the synchronization determination unit 14 determines that the participant terminal 10b is “asynchronous”.

Then, the display control unit 15 of the participant terminal 10b controls the display content on the display screen of the participant terminal 10b in accordance with the determination result of the synchronization determination unit 14 (S209). Here, the synchronization determination unit 14 determines that the participant terminal 10b is “asynchronous”. Thus, the display control unit 15 modifies the display content on the display unit 106 of the participant terminal 10b, and causes the second page of the materials A to be displayed even if the first page of the materials A is being displayed on the display unit 106 of the presenter terminal 10a.

In the processing of S205 to S209, the participant terminal 10b is in an asynchronous state (asynchronous mode), and different pieces of content are displayed on the presenter terminal 10a and the participant terminal 10b.

Then, the presenter P performs a desired operation on the presenter terminal 10a. Here, it is assumed that the presenter P writes characters on the first page of the materials A, which is being displayed on the display unit 106, with a pen tool (S102 in FIG. 8).

Then, the presenter terminal 10a notifies the participant terminal 10b of presenter operation information indicating the content of the operation performed by the presenter P (here, writing on the materials A with a pen tool), which includes information indicating the location (or coordinates) of the written characters, and the ID and page number of the materials A to which the characters are written.

Then, the presenter operation acceptance unit 11 of the participant terminal 10b accepts the presenter operation information from the presenter terminal 10a (S210).

Then, the operation type determination unit 13 of the participant terminal 10b determines an operation type in accordance with the presenter operation information (S211). Here, the operation type determination unit 13 refers to the operation type table illustrated in FIG. 6, and designates an operation type (“Pen”) corresponding to the content of the operation (“writing on the materials A with a pen tool”).

Then, the synchronization determination unit 14 of the participant terminal 10b determines whether the participant terminal 10b is synchronous or asynchronous, in accordance with the determination result of the operation type determination unit 13 (S212). Here, “Pen” is designated as the operation type. Thus, the synchronization determination unit 14 determines that the participant terminal 10b is “synchronous”.

Then, the display control unit 15 of the participant terminal 10b controls the display content on the display screen of the participant terminal 10b in accordance with the determination result of the synchronization determination unit 14 (S213). Here, the synchronization determination unit 14 determines that the participant terminal 10b is “synchronous”. Thus, the display control unit 15 modifies the display content on the display unit 106 of the participant terminal 10b, and causes the first page of the materials A, on which the characters have been written, to be displayed.

In the processing of S210 to S213, the participant terminal 10b reverts to the synchronous state (synchronous mode), and the same content is displayed on the presenter terminal 10a and the participant terminal 10b.

In the teleconferencing system 100, accordingly, the synchronous state and the asynchronous state are switched automatically in accordance with the desired operations performed by the presenter and the participant, and the display content of the participant terminal 10b is modified.

The configuration of the teleconferencing system 100 is not limited to the configuration described above, and the teleconferencing system 100 may have various configurations. In the following, a description will be given of the configuration of a teleconferencing system 100 according to each modification, focusing on a difference from the configuration described above. In the teleconferencing system 100 according to each of the following modifications, elements common to the teleconferencing system 100 described above in terms of function are not described.

In a teleconferencing system 100 according to a first modification, in a case where the participant operation acquisition unit 12 acquires the content of the operation performed by the participant (participant operation information), the display control unit 15 may make the participant terminal 10b asynchronous with the presenter terminal 10a (asynchronous mode), without determination of the operation type corresponding to the content of the operation, and may cause the display content corresponding to the content of the operation to be displayed on the participant terminal 10b. In a case where the presenter operation acceptance unit 11 accepts the content of the operation performed by the presenter (presenter operation information), the operation type corresponding to the content of the operation may be determined, and the display control unit 15 may make the participant terminal 10b synchronous with the presenter terminal 10a (synchronous mode), and may cause the display content corresponding to the content of the operation corresponding to the operation type to be displayed on the participant terminal 10b.

In the teleconferencing system 100 according to the first modification, the participant terminal 10b is in the synchronous state only when the presenter performs a meaningful operation (e.g., an operation corresponding to one of the operation types), for example, modifying the display content being displayed on the presenter terminal 10a, so that the display content corresponding to the operation is displayed on the participant terminal 10b, and, while the operation described above is not performed, the display content corresponding to the desired operation performed by the participant is displayed on the participant terminal 10b.

In a teleconferencing system 100 according to a second modification, in a case where the presenter operation acceptance unit 11 accepts the content of the operation performed by the presenter (presenter operation information), the display control unit 15 may make the participant terminal 10b synchronous with the presenter terminal 10a (synchronous mode), without determination of the operation type corresponding to the content of the operation, so that the display content corresponding to the content of the operation is displayed on the participant terminal 10b. In a case where the participant operation acquisition unit 12 acquires the content of the operation performed by the participant (participant operation information), the operation type corresponding to the content of the operation may be determined, and the display control unit 15 may make the participant terminal 10b asynchronous with the presenter terminal 10a (asynchronous mode), and may cause the display content corresponding to the content of the operation corresponding to the operation type to be displayed on the participant terminal 10b.

In the teleconferencing system 100 according to the second modification, the participant terminal 10b is in the asynchronous state only when the participant performs a meaningful operation (e.g., an operation corresponding to one of the operation types), for example, modifying the display content being displayed on the participant terminal 10b in synchronization with the presenter terminal 10a, so that the display content corresponding to the operation is displayed on the participant terminal 10b, and, while the operation described above is not performed, the display content corresponding to the desired operation performed by the presenter is displayed on the participant terminal 10b. In the teleconferencing system 100 according to the second modification, furthermore, an automatic transition to the synchronous state may be made at the time when the display content corresponding to the content of the operation performed by the participant is displayed on the participant terminal 10b.

In a teleconferencing system 100 according to a third modification, the display content corresponding to the content of the operation performed by the participant may be displayed on the participant terminal 10b with the presenter terminal 10a and the participant terminal 10b being maintained in a synchronous state. For example, while the presenter terminal 10a and the participant terminal 10b are in a synchronous state and the first page of the materials A is being displayed on the display screens of the presenter terminal 10a and the participant terminal 10b, if the participant switches to the second page, the display control unit 15 divides the display screen of the participant terminal 10b into a first screen for the synchronous mode and a second screen for the asynchronous mode so that the first page is displayed on the first screen to support the synchronous mode and the second page is displayed on the second screen to support the asynchronous mode. In this case, the first screen may have a smaller size than the second screen. The first screen and the second screen may be displayed side-by-side, or one of the first and second screens may be superimposed and displayed on top of the other screen. In the example described above, in response to the selection (or click) of the first screen by the participant, the display control unit 15 may cancel the asynchronous mode for the second screen, and may switch the first screen to a full-screen display view.

The teleconferencing system 100 according to the third modification allows the participant to display the content corresponding to the desired operation on the participant terminal 10b while viewing the same display content as that on the presenter terminal 10a.

In a teleconferencing system 100 according to a fourth modification, while the participant terminal 10b is in the asynchronous state, the asynchronous state may be maintained in accordance with instructions from the participant. For example, when the participant selects an asynchronous button on the display screen by using the mouse pointer, the participant terminal 10b is maintained in the asynchronous state. For example, the participant terminal 10b may be maintained in the asynchronous state while the participant is touching the display screen with their finger.

In the teleconferencing system 100 according to the fourth modification, furthermore, if the operation performed by the presenter while the participant terminal 10b is maintained in the asynchronous state corresponds to an operation type for a meaningful operation among multiple operation types, the asynchronous state may be forced to be canceled to initiate a transition to the synchronous state. Examples of the meaningful operation include displaying new materials and writing on the materials.

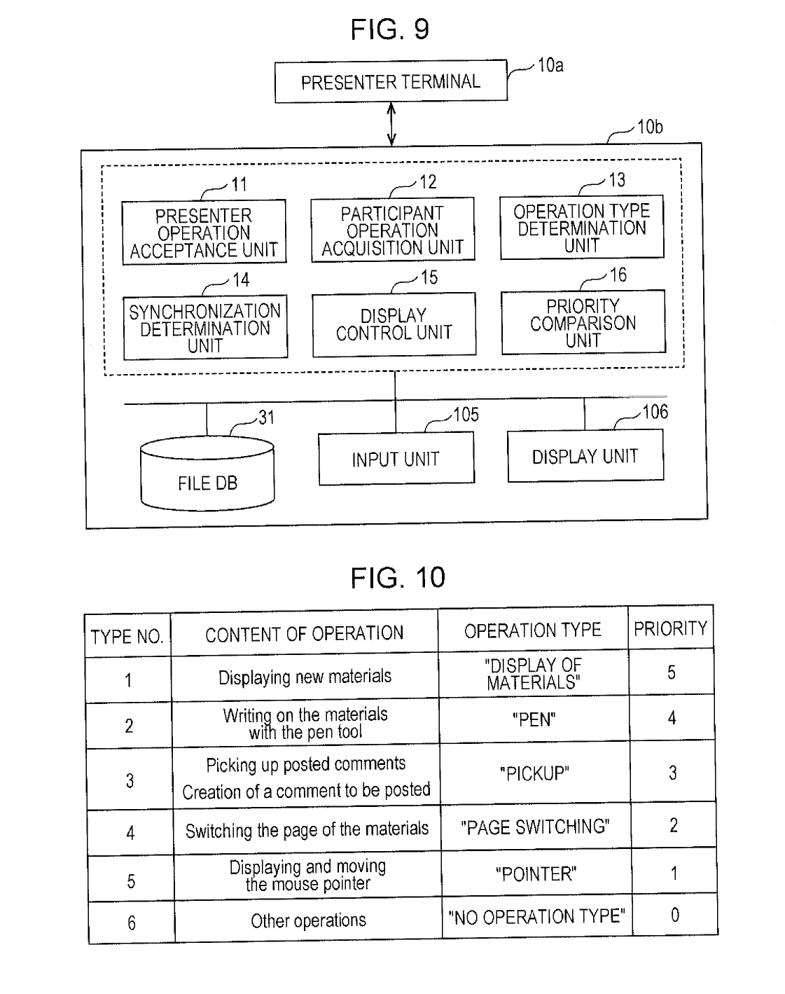

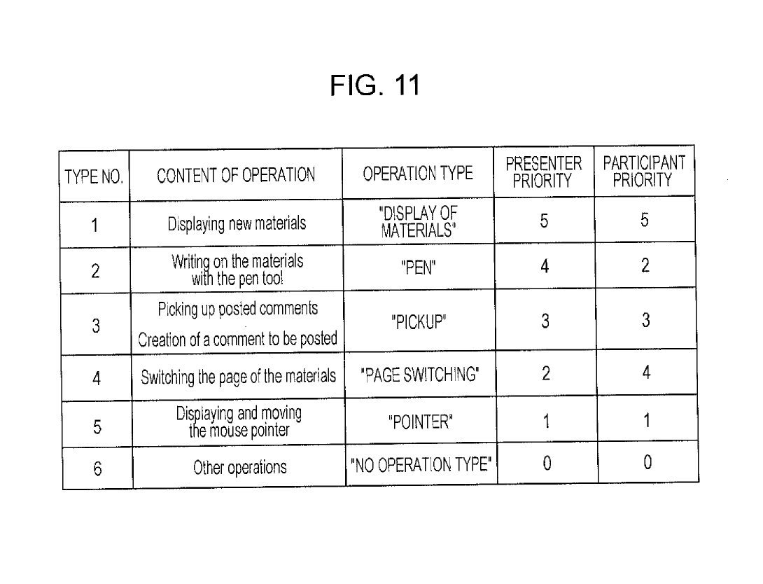

FIG. 9 is a functional block diagram illustrating a specific configuration of a participant terminal 10b in a teleconferencing system 100 according to a fifth modification. In the teleconferencing system 100 according to the fifth modification, the participant terminal 10b further includes a priority comparison unit 16. The priority comparison unit 16 acquires the priority (presenter priority) of an operation type corresponding to presenter operation information and the priority (participant priority) of an operation type corresponding to participant operation information for comparison. The priority represents the degree of meaningfulness of the content of the operation performed by the presenter or the participant. For example, as illustrated in FIG. 10, “Display of materials” is assigned the highest priority, and “Pen”, “Pickup”, “Page switching”, and “Pointer” are assigned priorities in descending order. The priorities are set in advance in an operation type table illustrated in FIG. 10. The presenter priorities and the participant priorities may be the same in the manner illustrated in FIG. 10, or may be different in the manner illustrated in FIG. 11.

In a case where the period during which the presenter operation acceptance unit 11 accepts presenter operation information and the period during which the participant operation acquisition unit 12 acquires participant operation information overlap, the priority comparison unit 16 compares the respective priorities.

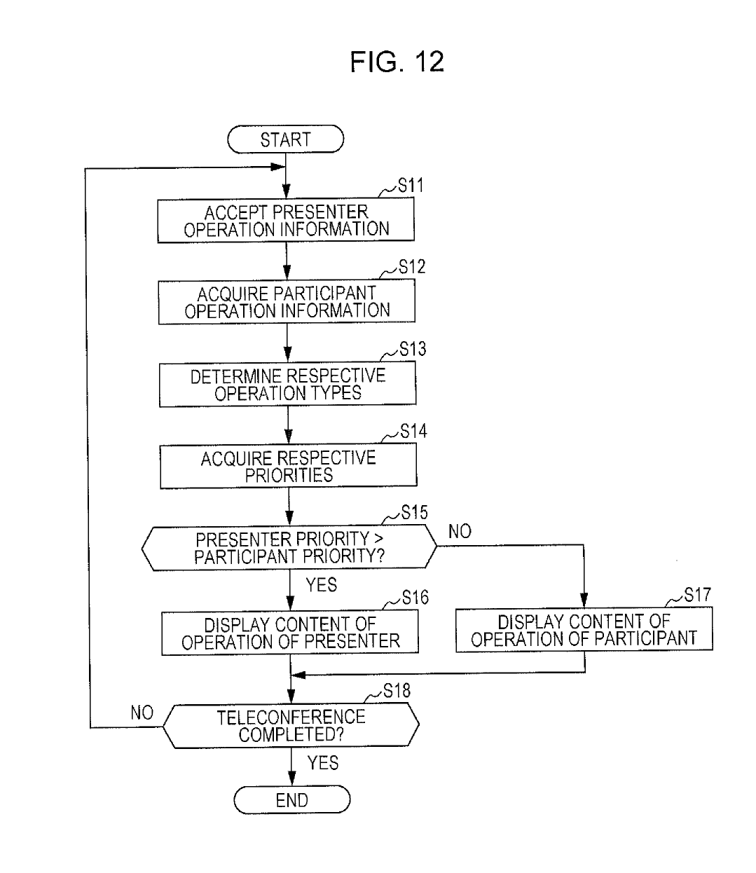

FIG. 12 is an operation flow diagram of the teleconferencing system 100 according to the fifth modification. First, in the participant terminal 10b, the presenter operation acceptance unit 11 accepts presenter operation information from the presenter terminal 10a (S11), and the participant operation acquisition unit 12 acquires participant operation information (S12). Then, the operation type determination unit 13 designates the operation type corresponding to the presenter operation information and the operation type corresponding to the participant operation information (S13). Then, the priority comparison unit 16 acquires the respective priorities of the respective operation types (the presenter priority and the participant priority) (S14), and determines whether or not the presenter priority is higher than the participant priority (S15). If the presenter priority is higher than the participant priority (YES in S15), the display control unit 15 causes the display content corresponding to the content of the operation performed by the presenter to be displayed on the display screen of the participant terminal 10b (S16). If the participant priority is equal to or higher than the presenter priority (NO in S15), the display control unit 15 causes the display content corresponding to the content of the operation performed by the participant to be displayed on the display screen of the participant terminal 10b (S17). If the participant priority is equal to the presenter priority, the presenter priority may be given priority. After the processing of S16 or S17, the process described above is repeatedly performed until the end of the teleconference (S18).

In the teleconferencing system 100 according to the fifth modification, accordingly, the display control unit 15 causes the display content corresponding to one of the presenter operation information and the participant operation information which has a higher priority to be displayed on the display screen of the participant terminal 10b. For example, the participant switches the page of the conference-material screen (see FIG. 5) displayed on the participant terminal 10b to a different page while the presenter is moving the mouse pointer across the conference-material screen (see FIG. 5) displayed on the presenter terminal 10a. In this case, since the participant priority (“2”) is higher than the presenter priority (“1”), the display control unit 15 does not reflect “movement of the mouse pointer” to the participant terminal 10b but reflects “Page switching” to the participant terminal 10b.

The configuration of the teleconferencing system 100 according to the fifth modification is not limited to the configuration described above. For example, the priority comparison unit 16 may compare the presenter priority with a predetermined value set in advance. The display control unit 15 may be configured so that, if the presenter priority is less than or equal to the predetermined value, the display content corresponding to the presenter operation information associated with the presenter priority will not be reflected to the participant terminal 10b.

The teleconferencing system 100 according to the fifth modification may also be configured such that, while display content corresponding to operation information having a high priority is being displayed on the participant terminal 10b, display content corresponding to other operation information is not accepted, and display content corresponding to other operation information is allowed to be accepted after the display content corresponding to the operation information having a high priority has been displayed on the participant terminal 10b. For example, while writing on materials with a pen tool is being performed on the participant terminal 10b (asynchronous state), the content of the operation performed by the presenter (for example, displaying new materials) may not be accepted, and the new materials may be displayed on the participant terminal 10b at the time when writing on the materials by the presenter is completed.

In a teleconferencing system 100 according to a sixth modification, the participant operation acquisition unit 12 may acquire participant operation information from the associated terminal, or from the participant terminal 10b, and also acquire participant operation information from another participant terminal, namely, the participant terminal 10c or 10d. That is, the participant operation acquisition unit 12 may be configured to also acquire operation information from any terminal other than the associated terminal. In the configuration described above, for example, if the operation in the participant operation information accepted from the participant terminal 10c corresponds to a predetermined operation type, the content of the operation may be reflected to the participant terminal 10b. With the configuration described above, for example, when a comment is posted using the participant terminal 10c, the posted comment is displayed on the participant terminal 10b.

The teleconferencing system 100 according to the exemplary embodiment and modifications described above may not necessarily include the synchronization determination unit 14. The teleconferencing system 100 that does not include the synchronization determination unit 14 will be described hereinafter as a teleconferencing system 100 according to a seventh modification.

In the teleconferencing system 100 according to the seventh modification, the display control unit 15 may control the display content on the display screen of the participant terminal 10b in accordance with the determination result of the operation type determination unit 13. Specifically, if the content of the operation performed by the presenter corresponds to a predetermined operation type (see FIG. 6), the display control unit 15 may cause the display content corresponding to the content of the operation to be reflected and displayed on the participant terminal 10b.

For example, the content of the operation performed by the presenter (for example, displaying the mouse pointer or writing with a pen tool) is reflected to the participant terminal 10b, and, in addition, if the operation performed by the participant is also displaying the mouse pointer or writing with a pen tool (on the same page), the content of the operation performed by the participant may also be reflected to the participant terminal 10b. That is, both the content of the operation performed by the presenter and the content of the operation performed by the participant may be reflected to the participant terminal 10b. This results in an intermediate state of the synchronous state and the asynchronous state (or a semi-synchronous state) in which the content of the operation performed by the presenter is reflected and the content of the operation performed by the participant is also reflected simultaneously. Accordingly, the display control unit 15 may achieve a semi-synchronous mode that is independent of the synchronous mode and the asynchronous mode. That is, the display control unit 15 may be configured to modify the display content displayed on the participant terminal 10b to display content including both the content of the operation performed by the presenter and the content of the operation performed by the participant.

In a case where the teleconferencing system 100 includes the synchronization determination unit 14, for example, a system according to an eighth modification may be constructed using the determination result of the synchronization determination unit 14.

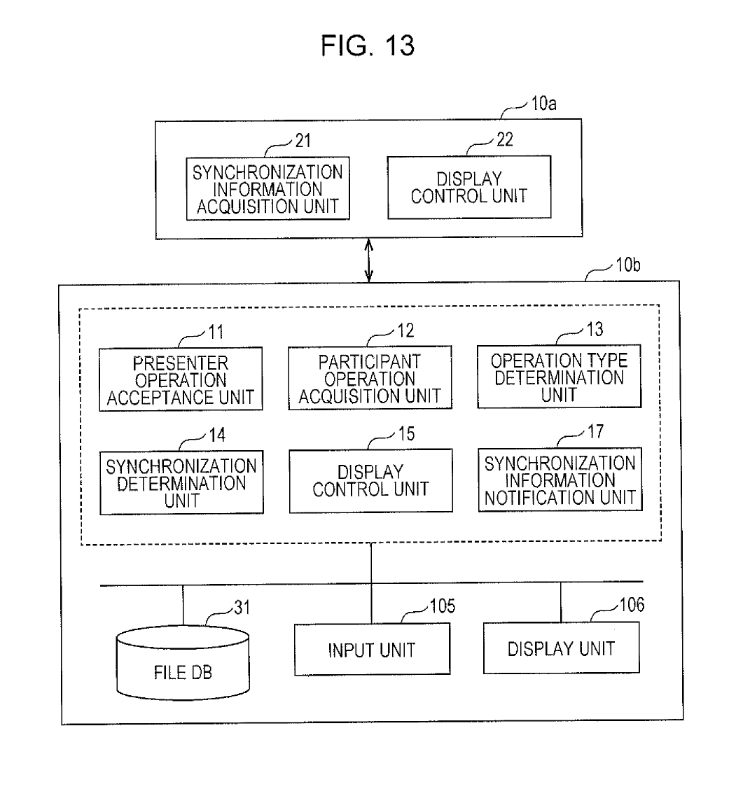

FIG. 13 is a functional block diagram illustrating a specific configuration of a teleconferencing system 100 according to the eighth modification. In the teleconferencing system 100 according to the eighth modification, the participant terminal 10b further includes a synchronization information notification unit 17, and the presenter terminal 10a further includes a synchronization information acquisition unit 21 and a display control unit 22.

The synchronization information notification unit 17 of the participant terminal 10b transmits synchronization information to the presenter terminal 10a. The synchronization information includes a synchronous state indicating whether or not the participant terminal 10b is synchronous with the presenter terminal 10a, the display content on the display screen when the participant terminal 10b is not synchronous, and so forth.

The synchronization information acquisition unit 21 of the presenter terminal 10a acquires the synchronization information from the participant terminal 10b. The synchronization information acquisition unit 21 acquires the synchronization information from all the participant terminals included in the teleconferencing system 100.

The display control unit 22 of the presenter terminal 10a controls the display content on the display screen of the presenter terminal 10a in accordance with the synchronization information acquired by the synchronization information acquisition unit 21. For example, the display control unit 22 calculates the total number of participant terminals that are synchronous (or the number of synchronous terminals) among all the participant terminals, and displays the number of synchronous terminals on the display screen of the presenter terminal 10a. The display control unit 22 may also calculate the ratio of the number of participant terminals that are synchronous to the total number of participant terminals (or the synchronous terminal ratio), and may display the synchronous terminal ratio on the display screen of the presenter terminal 10a. The display control unit 22 may also display pieces of display content being displayed on the display screens of participant terminals 10b that are in an asynchronous state side-by-side (for example, as thumbnails) on the display screen of the presenter terminal 10a.

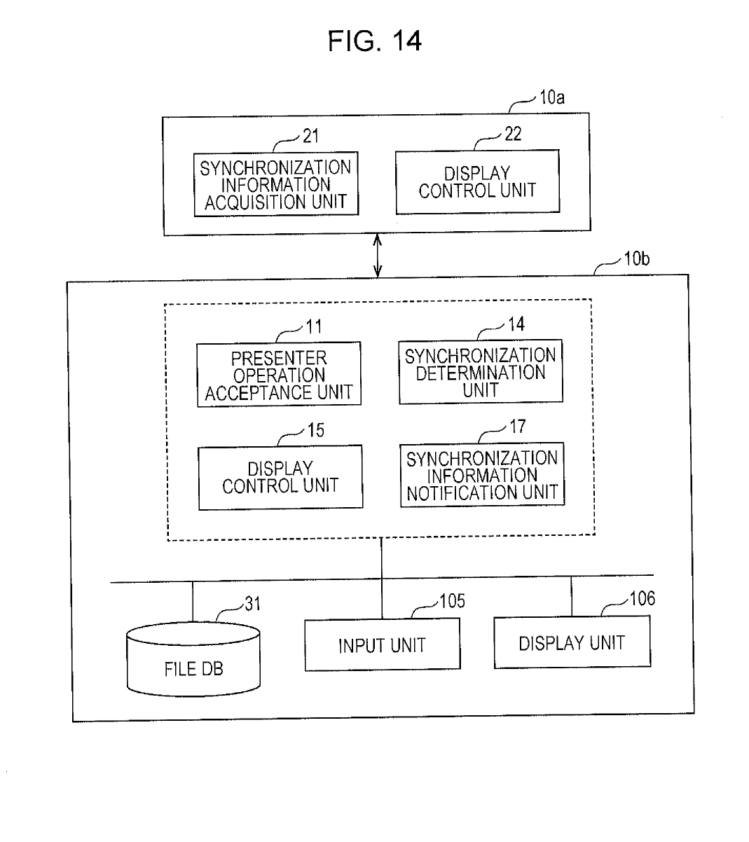

In a teleconferencing system 100 according to a ninth modification, the participant operation acquisition unit 12 and the operation type determination unit 13 are excluded from the participant terminal 10b in the teleconferencing system 100 according to the eighth modification. FIG. 14 is a functional block diagram illustrating a specific configuration of the teleconferencing system 100 according to the ninth modification. The presenter terminal 10a has the same configuration as that illustrated in FIG. 13. The participant terminal 10b may be a known terminal apparatus configured to achieve synchronous display. With the configuration described above, similarly to the eighth modification, the synchronous terminal ratio or the display content of the participant terminal 10b that is in an asynchronous state is displayed on the display screen of the presenter terminal 10a. This allows the presenter to understand the degree to which the participants have an interest in the presentation made by the presenter.

A program for implementing the teleconferencing system 100 according to the ninth modification may be a program for multiple terminal apparatuses, for allowing at least part of display content of the presenter terminal 10a (a second terminal apparatus) to be displayed on at least a portion of the display screen of the participant terminal 10b (a first terminal apparatus) in such a manner that the participant terminal 10b is in a synchronous state, the program causing a computer to function as a display control unit that causes the ratio of the number of participant terminals 10b that are in a synchronous state to the total number of participant terminals 10b (i.e., the synchronous terminal ratio) to be displayed on the display screen of the presenter terminal 10a. The display control unit may also cause the display content of a participant terminal 10b that is in an asynchronous state to be displayed on the display screen of the presenter terminal 10a.

The components of the teleconferencing system 100 illustrated in the exemplary embodiment and modifications described above may be implemented by execution of a program using a CPU in an information processing apparatus connected to the operation terminal 10 (the presenter terminal 10a, or the participant terminal 10b, 10c, or 10d) over a network. The information processing apparatus may be, for example, the server 30 illustrated in FIG. 4. In this case, in the information processing apparatus, the participant operation acquisition unit 12 acquires participant operation information from each participant terminal, the operation type determination unit 13 designates an operation type corresponding to each participant terminal, and the synchronization determination unit 14 determines whether each participant terminal is synchronous or asynchronous. Further, the display control unit 15 controls the display content on a display screen of each participant terminal in accordance with the determination result of the synchronization determination unit 14.

The exemplary embodiment and modifications described above are examples, and may be used in combination.

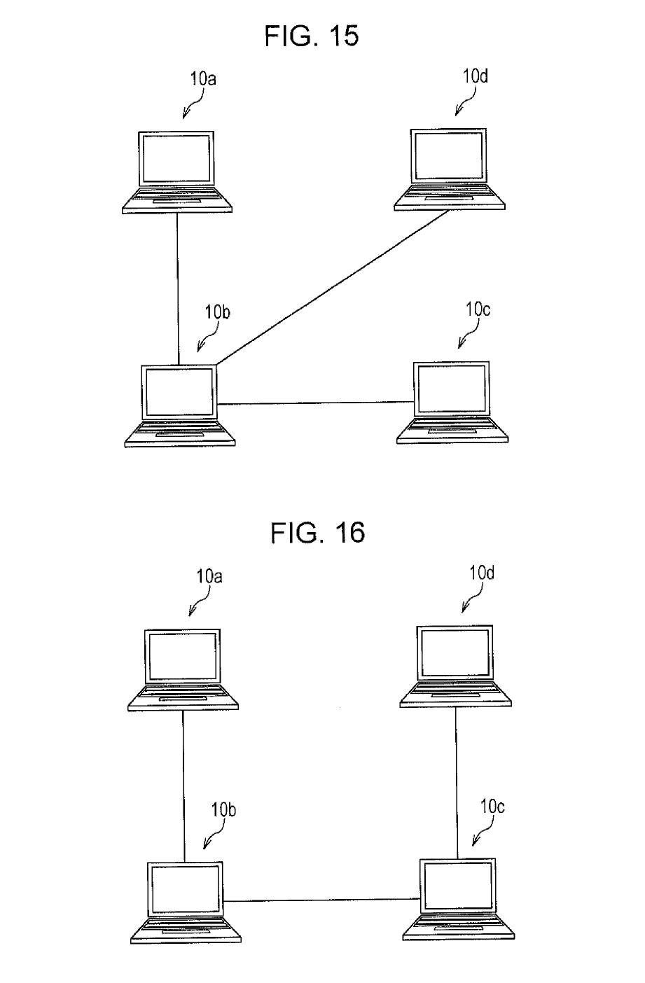

The network configuration of the teleconferencing system 100 is not limited to the configuration illustrated in FIG. 4. For example, as illustrated in FIG. 15, a configuration (star configuration) in which individual operation terminals 10 are connected to one another via the participant terminal 10b may be used. Alternatively, as illustrated in FIG. 16, a configuration (peer-to-peer (P2P) configuration) in which the participant terminals 10b, 10c, and 10d are connected using the presenter terminal 10a as the starting point may be used.

Furthermore, in the network configuration illustrated in FIG. 4, each operation terminal 10 may be connected to the server 30 in response to a user starting a web browser and designating a common URL (server), or may be automatically connected to the server 30 in accordance with an address at which an application to be started in each operation terminal 10 is set in advance. Alternatively, each operation terminal 10 may be connected to the server 30 via Web Socket, or each operation terminal 10 may access the server 30 at certain time intervals (polling) to exchange information between operation terminals 10 in a pseudo-manner.

The transition (or switching) from a synchronous state to an asynchronous state and vice versa in the teleconferencing system 100 is as follows. If the operation terminals 10 are initially (or by default) set in the asynchronous state, the asynchronous state is canceled and the transition to the synchronous state is made. If the initial state is the synchronous state, the synchronous state is canceled and the transition to the asynchronous state is made.

While a teleconferencing system has been discussed as an example of an information processing system, the information processing system is not limited to a teleconferencing system, and may include diverse systems that allow network-connected terminal apparatuses to share electronic data.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for allowing at least part of display content of a second terminal apparatus included in a plurality of terminal apparatuses to be displayed on at least a portion of a display screen of a first terminal apparatus included in the plurality of terminal apparatuses in such a manner that the first terminal apparatus is in a synchronous state, the process comprising:
acquiring first operation content indicating content of an operation performed by a first user on the first terminal apparatus; and
modifying, in a case where the first operation content indicates content of an operation of modifying display content displayed on the first terminal apparatus in synchronization with the second terminal apparatus and indicates content of a predetermined operation, the display content displayed on the first terminal apparatus to display content corresponding to the first operation content.

2. The non-transitory computer readable medium according to claim 1, wherein
the modifying includes switching the display content displayed on the first terminal apparatus to the display content corresponding to the first operation content.

3. The non-transitory computer readable medium according to claim 1, wherein
the modifying includes causing the display content displayed on the first terminal apparatus to be displayed on the first terminal apparatus, and also causing display content to which the display content displayed on the first terminal apparatus has been switched in accordance with the first operation content to be displayed on the first terminal apparatus.

4. The non-transitory computer readable medium according to claim 1, wherein
the process further comprises accepting second operation content indicating content of an operation performed by a second user on the second terminal apparatus, and
the modifying includes,
in response to acceptance of the second operation content while the display content corresponding to the first operation content is being displayed on the first terminal apparatus,
modifying the display content displayed on the first terminal apparatus to display content corresponding to the second operation content, in a case where the second operation content indicates content of an operation of modifying display content displayed on the second terminal apparatus and indicates content of a predetermined operation.

5. The non-transitory computer readable medium according to claim 1, wherein
the process further comprises accepting second operation content indicating content of an operation performed by a second user on the second terminal apparatus,
the predetermined operation indicated by the first operation content has a priority determined in advance in accordance with the content thereof, and the predetermined operation indicated by the second operation content has a priority determined in advance in accordance with the content thereof, and
the modifying includes,
in a case where a period during which the first operation content is acquired and a period during which the second operation content is accepted overlap and the priority of the first operation content is higher than the priority of the second operation content,
modifying the display content displayed on the first terminal apparatus to the display content corresponding to the first operation content.

6. The non-transitory computer readable medium according to claim 1, wherein
the process further comprises accepting second operation content indicating content of an operation performed by a second user on the second terminal apparatus,
the predetermined operation indicated by the first operation content has a priority determined in advance in accordance with the content thereof, and the predetermined operation indicated by the second operation content has a priority determined in advance in accordance with the content thereof, and
the modifying includes,
in a case where a period during which the first operation content is acquired and a period during which the second operation content is accepted overlap and the priority of the second operation content is higher than the priority of the first operation content,
modifying the display content displayed on the first terminal apparatus to display content corresponding to the second operation content.

7. The non-transitory computer readable medium according to claim 1, wherein
the plurality of terminal apparatuses include a plurality of first terminal apparatuses, and
the modifying includes causing a ratio of the number of first terminal apparatuses that are in the synchronous state to the total number of first terminal apparatuses to be displayed on a display screen of the second terminal apparatus.

8. A non-transitory computer readable medium storing a program causing a computer to execute a process for allowing at least part of display content of a second terminal apparatus included in a plurality of terminal apparatuses to be displayed on at least a portion of a display screen of a first terminal apparatus included in the plurality of terminal apparatuses in such a manner that the first terminal apparatus is in a synchronous state, the process comprising:
canceling the synchronous state in response to a predetermined operation performed by a first user of the first terminal apparatus; and
reverting to the synchronous state in response to a predetermined operation performed by a second user of the second terminal apparatus in a state where the synchronous state has been canceled.

9. An information processing apparatus that allows at least part of display content of a second terminal apparatus included in a plurality of terminal apparatuses to be displayed on at least a portion of a display screen of a first terminal apparatus included in the plurality of terminal apparatuses in such a manner that the first terminal apparatus is in a synchronous state, the information processing apparatus comprising:
a first operation acquisition unit that acquires first operation content indicating content of an operation performed by a first user on the first terminal apparatus; and
a display control unit that, in a case where the first operation content indicates content of an operation of modifying display content displayed on the first terminal apparatus in synchronization with the second terminal apparatus and indicates content of a predetermined operation, modifies the display content displayed on the first terminal apparatus to display content corresponding to the first operation content.

10. An information processing apparatus that allows at least part of display content of a second terminal apparatus included in a plurality of terminal apparatuses to be displayed on at least a portion of a display screen of a first terminal apparatus included in the plurality of terminal apparatuses in such a manner that the first terminal apparatus is in a synchronous state, the information processing apparatus comprising:
a synchronization cancellation unit that cancels the synchronous state in response to a predetermined operation performed by a first user of the first terminal apparatus; and
a re-synchronization unit that reverts to the synchronous state in response to a predetermined operation performed by a second user of the second terminal apparatus in a state where the synchronous state has been canceled.

11. An information processing system including a first terminal apparatus and a second terminal apparatus, for allowing at least part of display content of the second terminal apparatus to be displayed on at least a portion of a display screen of the first terminal apparatus in such a manner that the first terminal apparatus is in a synchronous state, the information processing system comprising:
a first operation acquisition unit that acquires first operation content indicating content of an operation performed by a first user on the first terminal apparatus; and
a display control unit that, in a case where the first operation content indicates content of an operation of modifying display content displayed on the first terminal apparatus in synchronization with the second terminal apparatus and indicates content of a predetermined operation, modifies the display content displayed on the first terminal apparatus to display content corresponding to the first operation content.
